(19) United States
(12) Patent Application Publication
(10) Pub. No.: US 2021/0248223 A1
(43) Pub. Date: Aug. 12, 2021

(54) SECURING DEVICES FROM NON-COMPLIANT TYPE-C DEVICES

(71) Applicant: QUALCOMM Incorporated, San Diego, CA (US)

(72) Inventors: Thirupathi CHIPPAKURTHY, Hyderabad (IN); Manu GAUTAM, Hyderabad (IN); Faisal HASSAN, Hyderabad (IN); Prakash TIWARI, Hyderabad (IN); Naga Chandan Babu GUDIVADA, Hyderabad (IN)

(21) Appl. No.: 16/784,862

(22) Filed: Feb. 7, 2020

(51) Int. Cl. G06F 21/44; G06F 9/54; G06F 21/85; G06F 21/12

(52) U.S. Cl. CPC G06F 21/44; G06F 21/123; G06F 21/85; G06F 9/541

(57) ABSTRACT

Techniques and apparatus for authenticating a second device by a first device includes detecting a physical attachment of the second device to the first device. In response to the detection, an indication of one or more capabilities of the second device is received and an authentication procedure with the second device is performed. A determination of whether to allow use of the one or more capabilities of the second device is made based on the authentication procedure. The first device interacts with the second device, in accordance with the determination.

### TECHNICAL FIELD

The present disclosure generally relates to power transfer and, more specifically, to techniques for authenticating devices for Universal Serial Bus (USB) Power Delivery (PD)-based battery charging.

### BACKGROUND

As portable devices proliferate, keeping the devices charged is increasingly important and, in some cases, tedious. Some users may have multiple devices (e.g., a smartphone, a Bluetooth® headset, a reader, a laptop, and so on) all needing to be charged, many of which use different charging standards that are incompatible with one another. These devices may also have different charging and/or power requirements. Managing one or more of multiple charging standards, different power transfer requirements, or different charging requirements for multiple devices may be onerous, and some of the current charging standards and/or implementations may reduce the charging efficiency and safety of the charging process that the multiple devices are capable of.

For example, an increasing number and variety of electronic devices are powered via rechargeable batteries. Such devices include mobile phones, portable music players, laptop computers, tablet computers, computer peripheral devices, communication devices (e.g., Bluetooth® devices), digital cameras, hearing aids, medical implants, and the like. While battery technology has improved, battery-powered electronic devices increasingly demand and consume variable amounts of power. As such, these devices may constantly require recharging. Rechargeable devices are often charged via wired connections that employ cables or other similar connectors that are physically connected to a power supply such as a USB cable.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include improved power charging and user experience.

Certain aspects of the present disclosure provide a method that may be performed by a first device for authenticating a second device physically attached to the first device. The method generally includes detecting a physical attachment of the second device to the first device and, in response to the detection, receiving an indication of one or more capabilities of the second device and performing an authentication procedure with the second device. The method also includes determining, based on the authentication procedure, whether to allow use of the one or more capabilities of the second device. The method further includes interacting with the second device, in accordance with the determination.

Certain aspects of the present disclosure provide an apparatus. The apparatus generally includes at least one processor configured to perform an operation for authenticating a device physically attached to the apparatus, and a memory coupled to the at least one processor. The operation includes detecting a physical attachment of the device to the apparatus and, in response to the detection, receiving an indication of one or more capabilities of the device and performing an authentication procedure with the device. The operation also includes determining, based on the authentication procedure, whether to allow use of the one or more capabilities of the device. The operation further includes interacting with the device, in accordance with the determination.

Certain aspects of the present disclosure provide a non-transitory computer readable medium having computer executable code stored thereon, which when executed by one or more computer processors of a first device, performs an operation for authenticating a second device physically attached to the first device. The operation generally includes detecting a physical attachment of the device to the apparatus and, in response to the detection, receiving an indication of one or more capabilities of the device and performing an authentication procedure with the device. The operation also includes determining, based on the authentication procedure, whether to allow use of the one or more capabilities of the device. The operation further includes interacting with the device, in accordance with the determination.

Certain aspects of the present disclosure provide an apparatus configured to authenticate a device physically attached to the apparatus. The apparatus generally includes means for detecting a physical attachment of the device to the apparatus and, in response to the detection, receiving an indication of one or more capabilities of the device and performing an authentication procedure with the device. The apparatus also includes means for determining, based on the authentication procedure, whether to allow use of the one or more capabilities of the device. The apparatus further includes means for interacting with the device, in accordance with the determination.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how aspects in accordance with the present disclosure may be practiced. In the accompanying drawings:

FIG. 1 is a functional block diagram of an example power transfer system, in accordance with certain aspects of the present disclosure.

FIG. 2A illustrates an example environment in which techniques for charging devices may be implemented.

FIG. 2B illustrates another example environment in which techniques for charging devices may be implemented.

FIG. 3 is a flow diagram of example operations for authenticating one device physically connected to another device, in accordance with certain aspects of the present disclosure.

FIG. 4 depicts an example authentication sequence that can be used by a first device to authenticate a second device attached to the first device.

FIG. 5 is a flowchart of an example security transfer process for an authentication initiator.

FIG. 6 is a flowchart of an example security transfer process for an authentication responder.

FIG. 7 illustrates an example user interface that can be provided on a display of a user device, according to certain aspects of the present disclosure.

FIG. 8 illustrates an example stack deployment of a sink device, in which the authentication is performed at a hardware layer, according to certain aspects of the present disclosure.

FIG. 9 depicts an example of a sink device configured to perform authentication of a source device via vendor defined messages, according to certain aspects of the present disclosure.

FIG. 10 illustrates an example vendor defined message format, according to certain aspects of the present disclosure.

FIG. 11 illustrates an authentication protocol that may be implemented based on vendor defined messages, according to certain aspects of the present disclosure.

FIG. 12 illustrates a sink with a dedicated subsystem that is configured to perform authentication, according to certain aspects of the present disclosure.

FIG. 13 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements described in one aspect may be beneficially utilized on other aspects without specific recitation. Aspects generally include methods, apparatus, systems, computer program products, computer-readable medium, and processing systems, as substantially described herein with reference to and as illustrated by the accompanying drawings.

### DETAILED DESCRIPTION

Aspects of the present disclosure provide apparatus, methods, processing systems, and computer-readable media for securing devices that may be connected via a data and/or power connection (e.g., USB Type-C) to one or more non-compliant devices (e.g., non-compliant USB Type-C devices). For example, the Universal Serial Bus (USB) Power Delivery (PD) specification is a widely adopted specification by the mobile industry and its communication protocol may be used to bring more intelligence to the power source and power sink. These features may allow for fast and efficient (and consistent) battery charging, as well as adaptive charging in USB PD-based systems. Many devices may charge, provide power, and/or get their power from a USB port that is provided on any number of devices. Particularly, a USB port has become a ubiquitous power socket for many small devices such as cell phones and other hand-held devices.

Recently, due in part to the popularity of the USB protocol, there has been a proliferation of devices that are not fully in compliance with the USB standard. For example, some of these devices may be counterfeit devices with malicious software. In another example, the devices may include devices that are not capable of supporting fast charging techniques (e.g., in accordance with the USB PD specification). Non-compliant USB devices can compromise the safety and/or security of the devices to which they are connected. For example, in some cases, a non-compliant (Type-C) adapter device (also referred to as a connector device) can damage devices connected to it (e.g., due to an over voltage supply from the non-compliant adapter device). Additionally, in some cases, a non-compliant USB device may include malicious embedded hardware and/or software that can be used to exploit a USB connection with another device.

To address this, aspects provide techniques for securing devices that may be connected to one or more non-compliant devices, e.g., via a USB connection. As described in more detail below, aspects allow a first (host) device that is connected to another second device to perform authentication with the second device, before using one or more capabilities of the second device. The authentication protocol may enable system and device manufacturers, as well as end users, to enable or disable capabilities based on trust levels established between a host and device. For example, a host device may authenticate a charger or cable before enabling high powered fast charging from a second device connected to the host device, preventing safety issues that can be caused by counterfeit devices. In another example, a host device may choose to ask a user to confirm the capabilities of a newly connected untrusted device before enabling capabilities that could potentially harm the host device or compromise network security. Accordingly, by enabling a host (or sink) device to perform authentication with another connected device, aspects can reduce (or even prevent) scenarios in which non-compliant chargers or non-compliant source devices cause damage to and/or compromise the security of the host device.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein.

In addition, the scope of the disclosure is intended to cover such an apparatus or method which is practiced using other structure, functionality, or structure and functionality in addition to or other than the various aspects of the disclosure set forth herein. It should be understood that any aspect of the disclosure described herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

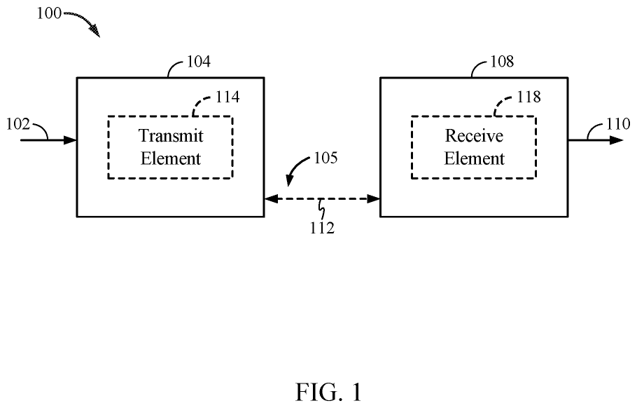

FIG. 1 is a functional block diagram of an example power transfer system 100, in accordance with certain aspects of the present disclosure. Input power 102 may be provided to a transmitter 104 from a power source (not shown in this figure) to generate a power transmittance 105 for performing energy transfer. A receiver 108 may be subjected to the power transmittance 105 and generate output power 110 for storing or consumption by a device (not shown in this figure) coupled to the output power 110. The transmitter 104 and the receiver 108 may be separated by a distance 112 along which the power transmittance 105 is transmitted using a power cable, such as a USB PD cable. In other cases, the cable may include pogo pins, and in some cases the power transmittance may be implemented using connector-less connections. The transmitter 104 may include a power transmitting element 114 for transmitting/providing energy to the receiver 108. The receiver 108 may include a power receiving element 118 for receiving/capturing energy transmitted from the transmitter 104.

In accordance with one or more aspects, the transmitter 104 and receiver 108 in certain cases may be able to change roles, and therefore, power transfer may change directions. An example is a power bank which may receive power from a device to be charged or may provide power for the device to charge.

In certain aspects, the power transmittance 105 may also carry an information signal nested in the power transmittance 105. The power transmittance 105 may correspond to a frequency region in which there may be low and/or consistent noise signatures resulting from the currents and charges in the power transmitting element 114 that radiate power away from the power transmitting element 114. The information signal may correspond to a region that may be within a select wavelength of the power transmitting element 114. Conversely, the information signal may correspond to a region that uses a number of wavelengths of the power transmitting element 114. In another example, the cable may include a number of different paths (also referred to as channels) and connection pins along which either power or an information signal may be transmitted. Accordingly, one or more pins/paths may be selected for data transfer while the other one or more pins may be selected for power transmittance 105.

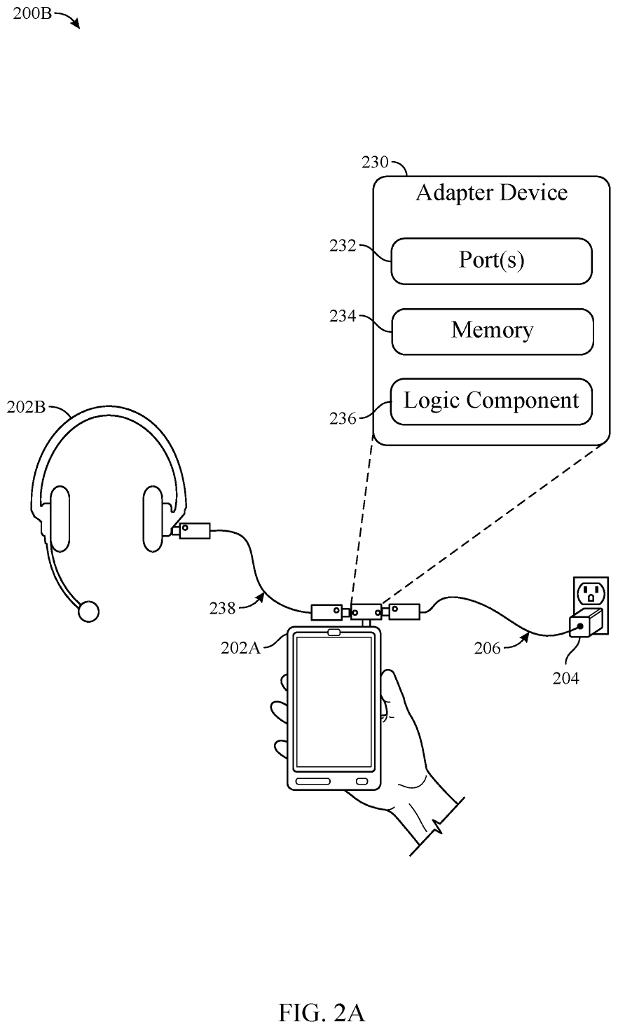

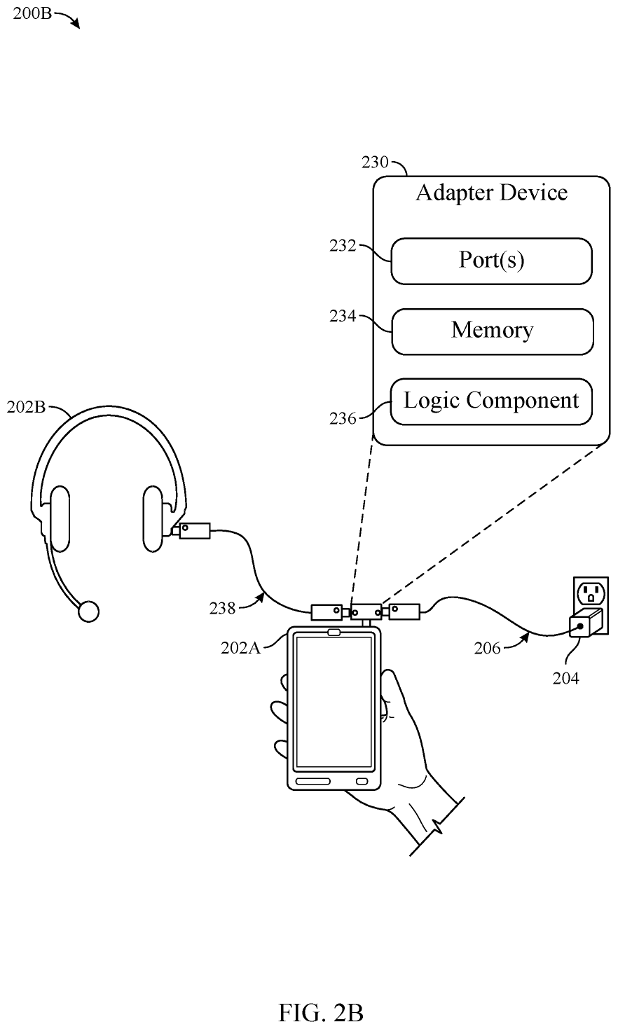

FIG. 2A illustrates an example environment 200A in which techniques for authenticating USB devices may be implemented. For example, FIG. 2A illustrates a computing device 202 communicatively coupled to a charger device 204 via a wired connection 206, such as a USB Type C-compliant (also referred to as USB PD-compliant) cable. The computing device 202 may also be communicatively coupled to a charger device 204 using a wireless network connection, a near field wireless connection, some other data connection, or some combination thereof. The computing device 202 is representative of a battery-powered electronic device having a battery 208 that may be rechargeable. Examples of the computing device 202 can include, but are not limited to, a laptop computer, a tablet, a smartphone, a mobile phone, a portable media player, a handheld gaming device, and so on. In addition, a computing device may be configured as a battery-operated child's toy, a broadcast receiver (e.g., baby monitor), a two-way radio, a remote control, a wireless gaming controller, headset (or headphone) device, and so on. Certain devices may perform power transmit and receive functions.

The computing device 202 and the charger device 204 may connect to a network that may assume a wide variety of configurations. For example, the network may include a wide area network (WAN), a local area network (LAN), a wireless network (WLAN), a wireless personal area network (WPAN) (e.g., Bluetooth®, Bluetooth® low energy (BLE), ZigBee®, and so on), a public telephone network, an intranet, and so on. Further, although a single network is one example, the network may be representative of multiple networks.

The computing device 202 is illustrated as including a variety of hardware components, examples of which include a charging port 210, one or more microprocessors 212, and an example of a computer-readable storage medium illustrated as memory 222. The microprocessor 212 is representative of functionality to perform operations through execution of instructions stored in the memory 222. Although illustrated separately, functionality of these components may be further divided, combined (e.g., on an application specific integrated circuit (ASIC)), and so forth.

The charging port 210 is representative of a port (e.g., a USB type-C port) via which a connection may be made with the charger device 204 in order to receive power to charge the battery 208. The charging port 210 may include any of a variety of configurations. Examples include a Universal Serial Bus (USB) port (e.g., a charging downstream port (CDP) or a dedicated charging port (DCP)), a port for a 19 volt circular-connector, a connector-less port (pogo pins), a wireless charging “port,” and so on. Accordingly, any of a variety of different wired charging ports 210 may be utilized to interface with a charging connector of a charger device or with multiple types of devices (e.g., via an USB adapter or USB hub).

The microprocessor 212 is illustrated as including at least a communication module 218 and an authentication component 220. In one aspect, the microprocessor 212 is a power management integrated circuit (PMIC). The communication module 218 is representative of functionality to communicate with the charger device 204. In implementations, charging port 210 may include, for example, other modules such as another communication module, a control module, a sensor module, and other modules. The communication module 218 supports communication via the wired connection 206. When the battery 208 reaches a certain low-level of charge, the communication module 218 may transmit to the charger device 204 a request for the charger device 204 to alert a user that the battery 208 of the computing device 202 needs charging and that the charger device 204 may be available to provide that charge. If the charger device 204 has previously been connected to the computing device 202, the charger device 204 may easily receive that request and respond accordingly. The charging port 210 may be configured to both receive and/or provide control signal, data signal, and other signals relating to charging the battery 208 of the computing device. The computing device 202 and the charger device 204 may be connected and exchange a unique ID. Once connected, any of a variety of networks (e.g., IEEE 802.11, Bluetooth®, BLE, ZigBee®, and so on in addition to the USB data connection) may be used to communicate with the user regarding charging of the computing device 202.

The authentication component 220 is configured to perform authentication with the charger device 204, e.g., before accepting or enabling one or more charging capabilities of the charger device 204. In one aspect, the authentication component 220 can perform authentication to determine an amount of charge current that the charger device 204 can use to charge the computing device 202. For example, based on the authentication procedure, the computing device 202 can limit the charge current to a default level, allow the charger device 204 to use a maximum charge current supported by the charger device 204, deny any charging from the charger device 204, etc. Once the capabilities are determined, the authentication component 220 may indicate the charging policy to the charger device 204, via the communication module 218.

The charger device 204 is illustrated as including a signal transmitter/receiver 224 and a memory 226. The memory 226 may include short-term volatile memory and/or random access memory (RAM) to store variables. The memory 226 may be used to store connection information (e.g., unique ID) between the charger device 204 and the computing device 202, system information about the charger device 204, and so on. In some cases, the charger device 204 may not include a memory. The signal transmitter/receiver 224 may transmit a message to the computing device 202 to indicate that the request was received. Additional information may be included in that message, such as an indication that the charger device 204 is available for charging.

The charger device 204 is available for charging if, for instance, the charger device 204 is plugged in to a power source (e.g., outlet), and is not currently charging another device or battery. The charger device 204, however, may not be required to be plugged in to a power source to be available, such as in the case of a power bank, which is a portable device that can supply USB power using stored energy in its built-in batteries. Accordingly, it may be appreciated that a power bank may power a computing device if the power bank is not connected to a power source and the power bank's own battery has capacity that may be used to charge the computing device. In this case, the charger device 204 may be available if the charger device 204 is not currently charging another device or battery, and has charge in the built-in batteries. In another example, the charger device 204 may be connected to a number of different devices that the charger device 204 is charging. In this case, the charger device 204, or one of the connected devices, may collect and generate power control information to determine how much power resources to assign to each device from the available charging resources of the charger device 204.

The charger device 204 is also illustrated as including a logic component 228. In implementations, the logic component 228 may include any of a variety of mechanisms capable of receiving, processing, generating, and/or transmitting power information signals. In some cases, the logic component 228 may include a simple analog or digital chip. Alternatively or in addition, the logic component 228 may be capable of transmitting information about the current and/or voltage being provided to the computing device 202. In at least one aspect, the charger device 204 may notify a user that the charger device 204 is available to charge the computing device 202 by generating an alert. The alert may also indicate compatibility of the charger device 204 with the computing device 202. Further, in certain aspects, the charger device 204 may incorporate features and functionality expected by the computing device 202 in an effort to achieve optimum, or at least desired, charging operation. The alert or another signal may indicate such capabilities of the charger device 204 to the computing device 202.

Because both the computing device 202 and the charger device 204 generate data and/or control signals for controlling the charging, the computing device 202 and/or the charger device 204 may influence the charging parameters to be implemented for the connected devices using the wired connection 206.

In implementations, the computing device 202 may determine a variety of useful information. For instance, the computing device 202 may determine the state of charge of the battery 208, temperature data at different monitored points in the system, and an availability of charge. The state of charge may be determined in any suitable way. For example, a sensor, such as a battery gauge, may be used to monitor a state of charge of the battery 208. When the state of charge reaches a certain level of charge (e.g., below a predefined or user-defined threshold), the microprocessor 212 determines that the battery is low.

The availability of charge may be determined in a variety of ways. For example, if the charger device 204 is unplugged, then the charger device 204 is likely unavailable to charge. A battery-powered charger is likely not available if the charger has not completed charging itself. A battery recharger is likely not available if the recharger has not completed recharging a battery pack. If the charger device 204 is not available for charging, then the charger device 204 does not send a message to the computing device 202 to indicate availability, and does not generate an alert to notify the user. Instead, the charger device 204 may remain silent or non-responsive, which indicates that the charger device 204 may be unavailable. Otherwise, the charger device 204 may send the availability message if the charger device 204 is available for charging.

FIG. 2B illustrates another example environment 200B in which techniques for authenticating USB devices may be implemented. Here, FIG. 2B illustrates a computing device 202A (e.g., smartphone) communicatively coupled to a charger device 204 and a computing device 202B (e.g., headset device) via an adapter device 230. The computing device 202B is coupled to the adapter device 230 via a wired connection 238 (e.g., a USB Type-C compliant cable) and the charger device 204 is coupled to the adapter device 230 via a wired connection 206 (e.g., USB Type-C compliant cable).

The adapter device 230 includes multiple ports 232 for connecting multiple devices to the computing device 202A. Here, for example, the adapter device includes two ports 232, where one port is used for connecting headset devices (e.g., computing device 202B) and the other port is used for connecting charger devices (e.g., charger device 204). The ports 232 may be USB Type-C ports. The adapter device 230 may also include memory 234 and logic component 236. The memory 234 may include short-term volatile memory and/or random access memory (RAM) to store variables. The logic component 236 may include any of a variety of mechanisms capable of receiving, processing, generating, and/or transmitting power information signals. In some cases, the logic component 228 may include a simple analog or digital chip.

In some cases, the adapter device 230 may not be compliant with a standard (e.g., USB Type-C standard) that is supported by one or more of the communication devices 202 A-B and the charger device 204. Such non-compliance can damage the devices that are connected to the adapter device 230 and/or pose security risks to the devices that are connected to the adapter device 230. For example, assume that the adapter device 230 is configured to share an internal input (e.g., USB_IN) between the computing device 202B and the charger device 204. Further assume that the charger device 204 is a fast charging device that supports a charging current at or above a first threshold (e.g., 9V DC) and that the computing device 202B is configured to accept a maximum charging current at a second threshold (below the first threshold) (e.g., 5V DC). In this example, because the adapter device 230 shares an internal input between the computing device 202B and the charging device 204, the computing device 202B can get damaged (e.g., due to an over voltage supply) if the charging device 204 is also connected to the adapter device 230.

Continuing with the above example, with a non-compliant adapter device 230, it may not be possible to switch the charging current of the charging device 204 from the first threshold to the second threshold after the charging device 204 has started charging. In some cases, this may be due, in part, to an inability to recognize the computing device 202B as a compliant device. For example, detecting the computing device 202B as compliant with a standard (e.g., USB Type-C) during fast charging (e.g., attached mode) may involve a V_{BUS} removal (e.g., unattached mode). This may not happen, however, with non-compliant adapter devices.

Further, with a non-compliant adapter device 230, there may be several issues associated with charging depending on which devices are connected to the adapter device 230 and the order in which the devices are connected to the adapter device 230. For example, in a first scenario, assume that the adapter device 230 is initially inserted into the computing device 202A by itself (e.g., without the charger device 204 and the computing device 202B). In response to this initial condition, the adapter device 230 may be detected as a sink by the computing device 202A and the computing device 202A may be put in source mode (e.g., Rd/open). For example, the computing device 202A may be configured to provide charging (e.g., at 5V in a reverse boost scenario).

Continuing with the first scenario, the computing device 202A may have various responses depending on the subsequent trigger event. For example, assume that the computing device 202B is subsequently inserted into the adapter device 230. In this case, the computing device 202B may begin to receive power (e.g., from the computing device 202A via the adapter device 230). In some cases, this response may depend on whether the computing device 202A transitions from Rd/open state to a dual-role power (DRP) state or Ra/open state (e.g., depending upon the impedance presented by the computing device 202B on the configuration channel 1 (CC1) pin).

In another example, assume that a legacy charger device 204 is subsequently inserted into the adapter device 230. In this case, there may be a fight between V_{BUS} and the charger device 204 in reverse boost and external boost. In yet another example, assume that a Type-C compliant charger device 204 is subsequently inserted into the adapter device 230. In this case, the adapter device 230 may not output 5V, since it may already see 5V on V_{BUS.}

In a second scenario, assume that the charger device 204 is initially inserted into the adapter device 230 and that the adapter device 230 is subsequently inserted into the computing device 202A. In response to this initial condition, assuming a legacy charging device 204 is used, it will present a voltage on V_{BUS}. Note, however, that if the legacy charging device 204 supports a version of Quick Charge (QC), a higher voltage may be negotiated. In cases where a Type-C charging device 204 is used, the charging device 204 may see Rd from the adapter device 230 and present a voltage on V_{BUS}. This, in turn, may cause the computing device 202A to detect the Type-C charging device 204 as a legacy charging device since it will see V_{BUS} and CC at the same time. In this case, there may not be a PD contract, e.g., between the Type-C charging device 204 and the computing device 202A. Note, however, that in some cases, a PD negotiation may be attempted, even in the case of a legacy connection, if there is a cold boot of the computing device 202A. In response to the adapter device 230 being inserted into the computing device 202A, the computing device 202A may be put in sink mode (e.g., since there may be two Rd in parallel on the CC line, one from the adapter device 230 and one from the computing device 202A).

Continuing with the second scenario, if a Type-C compliant computing device 202B is subsequently inserted into the adapter device 230, then the computing device 202B may receive power and may get damaged (e.g., if V_{BUS} is at a high voltage). In some cases, similar to the first scenario, this response may depend on whether the computing device 202A transitions from Rd/open state to a DRP state or Ra/open state (e.g., depending upon the impedance presented by the computing device 202B on the CC1 pin).

Lastly, in a third scenario, assume that a Type-C compliant computing device 202B is initially inserted into the adapter device 230 and that the adapter device 230 is subsequently inserted into the computing device 202A. In response to this initial condition, the adapter device 230 may be detected as a sink (Rd/open) by the computing device 202A or Ra/open (e.g., depending upon the impedance presented by the computing device 202B on the CC1 pin). If the computing device 202A detects Rd/open, then the computing device 202A may be configured to provide charging (e.g., at 5V in a reverse boost scenario). Alternatively, if the computing device 202A detects Ra/open, then the computing device 202A may continue to toggle in DRP operation.

Continuing with the third scenario, assuming that a legacy charging device 204 is subsequently inserted into the adapter device 230, then the legacy charging device 204 may present a voltage on V_{BUS}. Here, if the computing device 202A was in Rd/open mode, there may be a fight between the V_{BUS} and the charging device 204 in reverse boost and external boost. In another case, assuming that a Type-C charging device 204 is subsequently inserted into the adapter device 230, then the computing device 202A may not output 5V (e.g., since it may already see 5V on V_{BUS}), assuming the computing device 202A was in Rd/open mode.

To address the issues associated with using non-compliant USB devices, aspects presented herein enable devices to perform authentication (e.g., USB Type-C authentication) with connected devices. As noted above, by doing so, aspects can enable devices to protect against damage from non-compliant USB chargers and/or source devices as well as mitigate risks from maliciously embedded hardware or software in USB devices attempting to exploit the USB connection. For example, as described in more detail below, for a traveler that is concerned about charging their phone at a public terminal, their phone, using the techniques presented herein, can implement a policy that restricts charging to certified USB charging devices. In another example, a company tasked with protecting corporate assets, documents, and other information can set a policy in their company provided electronic devices (e.g., laptops) that grants access to verified USB storage devices in a compute domain. In yet a further example, aspects may provide a user interface that allows users to control charging parameters from a charging device 204, and/or control whether to allow a device connection with a connected charger/device. This can reduce the chances of a device overheating due to using non-compliant cables or other non-compliant connectors.

### Example Techniques for Securing Devices From Non-Compliant Type-C Devices

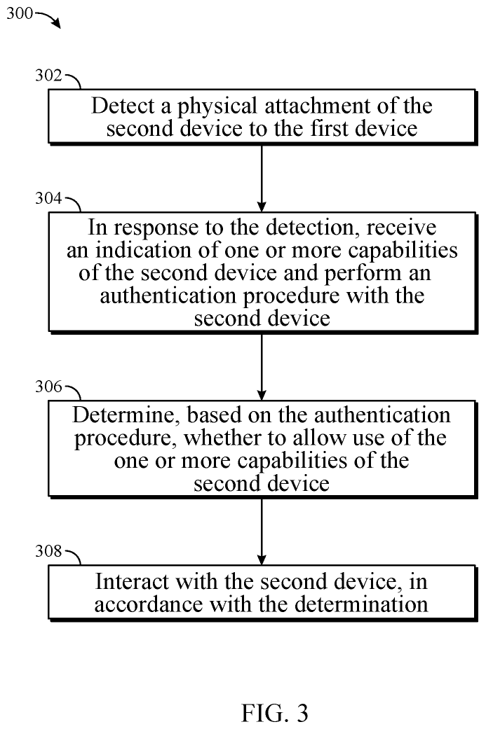

FIG. 3 is a flow diagram of example operations 300 for authenticating a device, according to certain aspects of the present disclosure. The operations 300 may be performed, for example, by a first device to authenticate a second device that is physically attached to the first device via a wired connection (e.g., USB cable). In some aspects, the first device, for example, may be a sink device, which may be a smartphone, tablet, etc. In some aspects, the second device, for example, may be a source device, which may be a charging device (e.g., charging device 204).

The operations 300 may begin, at block 302, where the first device detects a physical attachment of the second device to the first device. At block 304, the first device receives, in response to the detection, an indication of one or more capabilities of the second device and performs an authentication procedure with the second device. At block 306, the first device determines, based on the authentication procedure, whether to allow use of the one or more capabilities of the second device. At block 308, the first device interacts with the second device, in accordance with the determination.

In one aspect, the authentication procedure may be a hardware-based authentication procedure. For example, the hardware-based authentication procedure may be performed at a physical layer of the first device. In one aspect, the authentication procedure may be a software-based authentication procedure. For example, the software-based authentication procedure may be based on an exchange of one or more vendor-defined messages with the second device. In another example, the software-based authentication procedure may be performed by an audio digital signal processor (ADSP) of the first device.

In one aspect, the one or more capabilities may include at least one of: (i) support for charging at one or more supported charge currents or (ii) support for data exchange. In one aspect, performing the authentication procedure may include determining whether the second device supports a same maximum charging current (e.g., 9V PD) supported by the first device. Additionally or alternatively, in one aspect, performing the authentication procedure may include determining whether the second device is in compliance with a standard. For example, the standard may be based on a USB Type-C PD specification.

In one aspect, determining whether to allow use of the one or more capabilities of the second device may include determining whether to allow use of a subset of the one or more capabilities of the second device if the second device is not successfully authenticated. The subset of the one or more capabilities may include a charge current below a predefined threshold charge current (e.g., 5V). In one aspect, determining whether to allow use of the one or more capabilities of the second device may include determining to allow use of the one or more capabilities of the second device if the second device is successfully authenticated.

In one aspect, the operations 300 may further include prompting a user to approve use of the one or more capabilities of the second device, based on the authentication, prior to interacting with the second device. In this aspect, the determination whether to allow use of the one or more capabilities of the second device may be further based on whether the user has approved use of the one or more capabilities of the second device.

As noted above, in some aspects, the authentication procedure (e.g., at block 304) may be based on a standard (e.g., USB Type-C (PD) Authentication). For example, the USB Type-C specification generally defines a certificate-based method for authentication that allows a product (or device) to authenticate another attached product (or device) and, by policy, choose how to interact with that product. As an example, a sink device may choose to not use the full advertised capabilities of an unauthenticated source device (e.g., and instead use a subset of the full advertised capabilities). The authentication procedure can be initiated by a sink, a source, or a host. Additionally, USB PD is generally a port-to-port communication protocol. Because of this, authenticating devices that are connected downstream of a USB hub may involve implementing a USB Type-C bridge function in both the USB hub and the corresponding driver in the USB host. The USB Type-C bridge may be used to translate PD requests to the USB data domain.

The authentication procedure may involve an exchange of various messages e.g., between the sink and source. For example, assuming USB Type-C authentication is employed, the authentication initiator can query an authentication responder for certificate chain digests, read a certificate chain from the authentication responder, and challenge the authentication responder in order to verify its authenticity. As used herein, a “certificate” may refer to a digital form of identification that provides information about an entity and certifies ownership of a particular public key. As used herein, a “certificate chain” may refer to a series of multiple certificates, where each certificate is signed by the preceding certificate in the chain. In general, each certificate chain may correspond to a private key whose corresponding public key is certified. Thus, the authentication procedure involves confirming that a given authentication responder has access to their unique private key.

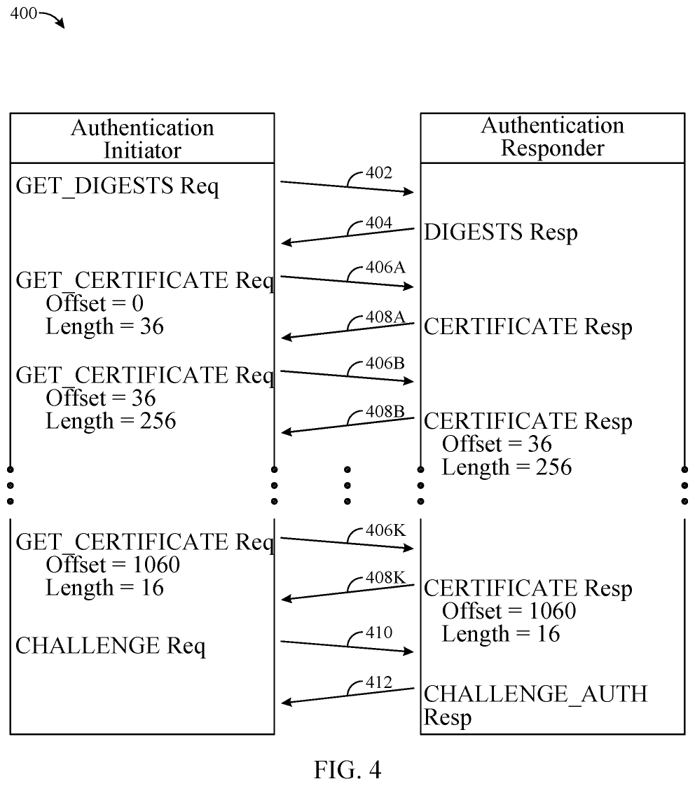

FIG. 4 depicts an example authentication sequence 400 that can be used by a first device to authenticate a second device attached to the first device. As shown, the authentication initiator may transmit a “GET_DIGESTS” request to the authentication responder (402) to retrieve certificate chain digests from the authentication responder. As shown, in response, the authentication initiator receives certificate chain digest(s) in a “DIGESTS” response from the authentication responder (404). After receiving a “DIGESTS” response, the authentication initiator compare digests in the “DIGESTS” response to cached digests (e.g., to see if the authentication initiator has any of the authentication responder's certificate chains cached.) If the authentication initiator does have the authentication initiator's digests, the authentication initiator may be able to skip reading a certificate chain, saving time in the authentication procedure.

In this example, the authentication initiator does not find a match and, therefore, sends a “GET_CERTIFICATE” request in order to retrieve and read a certificate chain from the authentication responder (406A). If the authentication responder receives a “GET_CERTIFICATE” request that targets an offset that is outside the certificate chain (e.g., offset>length) or attempts to read beyond the length of the target certificate chain (e.g., (offset+length)>certificate chain length), then the authentication responder may return an “ERROR” as the authentication response. Otherwise, as shown, the authentication responder may respond with a “CERTIFICATE” response (408A).

In this example, the authentication initiator may read the first 36 bytes of the certificate chain to get the length (e.g., 1076 bytes) and the root certificate (e.g., the first certificate in the certificate chain). The authentication initiator and the authentication responder may exchange “GET CERTIFICATE” requests and “CERTIFICATE” responses, respectively, until the authentication initiator has read all certificates in the certificate chain (406 A-K, 408 A-K). Here, for example, the authentication initiator may start at offset 36 and read 1040 bytes total in 256-byte segments. For each received “GET_CERTIFICATE” request, the authentication responder may verify that offset and length are within the certificate chain prior to sending the “CERTIFICATE” response.

The authentication initiator may verify the validity of signatures for each certificate in the certificate chain and then authenticate the responder, e.g., by sending a “CHALLENGE” request (410). In response, the authentication responder may send a “CHALLENGE_AUTH” response (412). The “CHALLENGE_AUTH” may include a context hash field, which may be zero for PD sources, sinks, cable plugs, and PD alternate mode devices. The context hash field, may include a 32-byte Secure Hash Algorithm (SHA)-256 hash of the following USB descriptor data for current operating speed, concatenated together in the following order: (1) device descriptor; (2) complete Binary Device Object Store (BOS) descriptor (if present); (3) complete configuration 1 descriptor; (4) complete configuration 2 descriptor (if present); and so on. The contents of each descriptor should match that which the device presents during enumeration at the USB device's current connection.

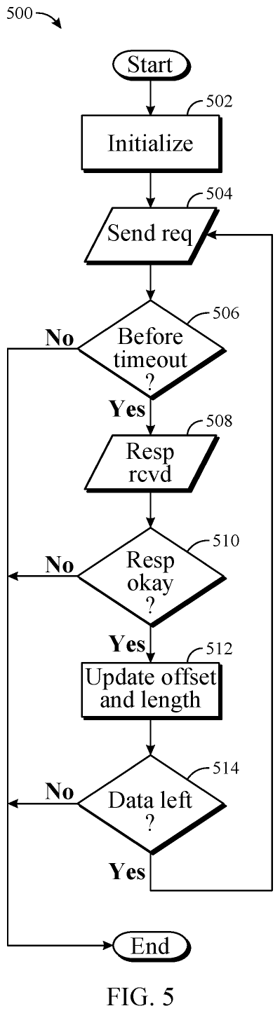

FIG. 5 is a flowchart of an example security transfer process 500 for an authentication initiator. The security transfer process 500 may be used to send “GET_DIGESTS” requests, “GET_CERTIFICATE” requests, and “CHALLENGE” requests.

As shown, at block 502, the authentication initiator performs an initialization procedure by initializing the “offset,” “length,” size of the request (e.g., number of bytes a single request can request), and remaining number of bytes to retrieve before security transfer process is complete. After initialization, the authentication initiator sends a request (504). If time has not expired (506), the authentication initiator receives a response (508) and determines whether the response is okay (510). If so, the authentication initiator updates the offset and length (512). If the response is not okay, the security transfer process exits. After updating the offset and length, the authentication initiator determines whether there is data left. If there is data remaining, the authentication initiator performs block 504.

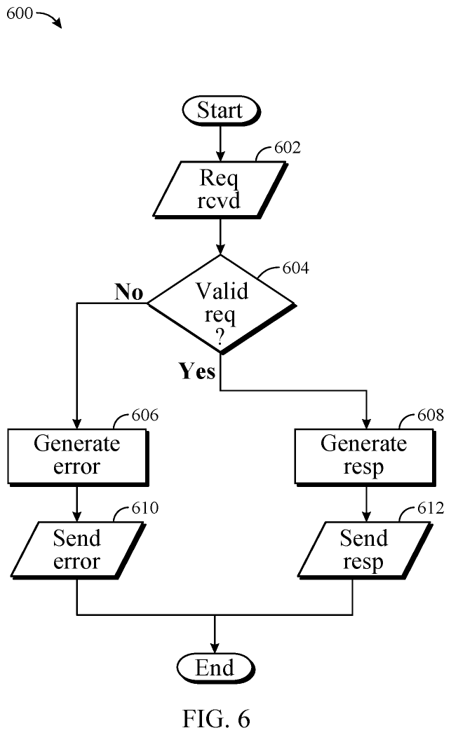

FIG. 6 is a flowchart of an example security transfer process 600 for an authentication responder. The security transfer process 500 may be used to send “DIGESTS” responses, “CERTIFICATE” responses, and “CHALLENGE_AUTH” responses.

As shown, at block 602, the authentication responder receives a request (602) and determines whether the request is valid (604). If the request is valid, the authentication responder generates (608) and sends the response (612). If the request is not valid, the authentication responder generates (606) and sends an error (610).

Referring back to FIG. 3, as noted above, the operations 300 may further include prompting a user to approve use of the one or more capabilities of the second device, based on the authentication, prior to interacting with the second device. In this aspect, the determination of whether to allow use of the one or more capabilities of the second device (at block 306) may be further based on whether the user has approved use of the one or more capabilities of the second device.

For example, in one aspect, the first device can prompt the user to decide whether to charge with a maximum charging current level or a minimum charging current level when authentication succeeds or fails. In one aspect, the first device can prompt the user to decide whether to enable/disable USB transfer options for unauthorized/non-authenticated hosts. In one aspect, if multiple devices support PD over a Type-C to Type-C connection, the user can be prompted to enable/disable charging based on an amount of battery charging that is needed. In one aspect, before a maximum current is drawn from the second device (e.g., charging device 204), the user may be prompted to set a charging current limit (e.g., that applies when a non-compliant charging device is connected). In some cases, aspects may provide a user with the control to enable/disable charging based on need. For example, the device (source or sink) can stop/start charging based on a battery condition.

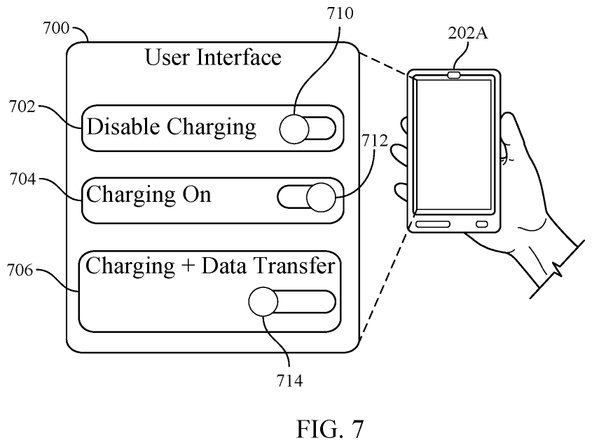

FIG. 7 illustrates an example user interface 700 that can be provided on a display of a user device (e.g., computing device 202A), according to certain aspects of the present disclosure. In some aspects, the user interface 700 may be a touch screen interface. Here, the user interface 700 includes a “Disable Charging” control 702, a “Charging On” control 704, and a “Charging +Data Transfer” control 706. The “Disable Charging” control 702 allows the user to disable charging automatically when certain conditions are satisfied. For example, if the battery percentage indicates that the battery has reached a threshold level (e.g., 90%, 100%, etc.) and the charging device 204 is still connected to the computing device 202A, the computing device 202A can be configured to automatically disable charging if the “Disable Charging” control 702 is enabled. Providing a user with the ability to disable charging in this manner can help improve battery life (e.g., by avoiding continuous re-charging of the battery cells). The “Disable Charging” control 702 can be enabled/disable by sliding the button 710.

The “Charging On” control 704 allows the user to enable/disable a charging capability of a device (e.g., by sliding button 712) connected to the computing device 202A (e.g., based on success/failure of the authentication procedure). In some aspects, the “Disable Charging” control 704 may be enabled/disabled by default (e.g., before the computing device 202A is attached to another device and/or prior to an authentication procedure). The “Charging +Data Transfer” control 706 allows the user to enable/disable a charging capability in addition to data transfer capability of a device (e.g., by sliding button 714) connected to the computing device 202A (e.g., based on success/failure of the authentication procedure). In some aspects, the “Charging +Data Transfer” control 706 may be enabled/disabled by default (e.g., before the computing device 202A is attached to another device and/or prior to an authentication procedure).

Note that the user interface 700 is provided merely as a reference example of a user interface that can be provided on a display of a computing device to enable a user to control charging and/or data transfer features of devices connected to the computing device. In other aspects, the user interface 700 can be configured to include additional and/or different control options (e.g., a charging current level control).

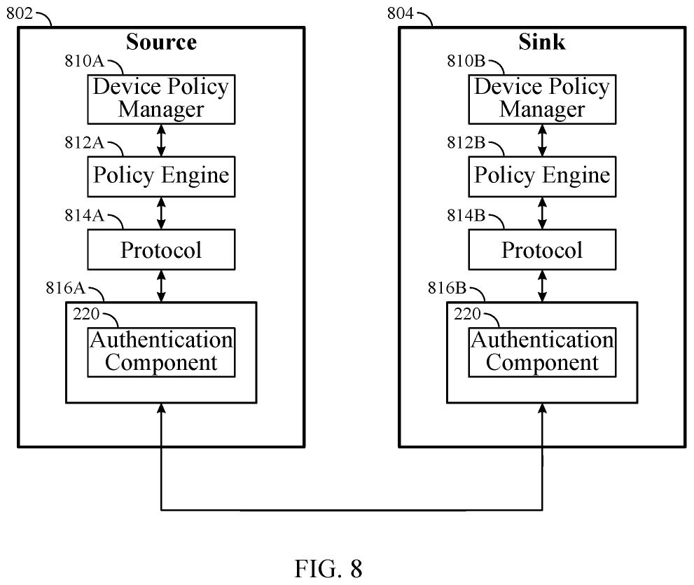

In some aspects, the authentication procedure (at block 304) may be a hardware-based authentication procedure. That is, the authentication may be incorporated/performed at a hardware layer of the first device. FIG. 8 illustrates an example stack deployment of a sink device, in which the authentication is performed at a hardware layer, according to certain aspects of the present disclosure.

Here, the communications stack in each of the source 802 and the sink 804 includes a device policy manager (810A, 810B), a policy engine (812A, 812B), a protocol layer (814A, 814B), and a physical (PHY) layer (816A, 816B). The device policy manager 810 is generally configured to interact with the USB interface in each device in order to provide and update PD related information in the USB domain. The device policy manager 810 may provide mechanisms to monitor and control a PD system within the device. For example, the device policy manager 810 may enact local polices on a per port basis via control of the source/sink ports and via communication with the policy engine 812. The policy engine 812 is generally responsible for implementing a local policy for its corresponding port. In some aspects, the policy engine 812 may interact with the device policy manager 810 in order to determine which local policy to enforce.

The protocol layer 814 may form messages used to communicate information between a pair of ports. For example, it can form capabilities messages, requests, and acknowledgements. The protocol layer 814 may receive inputs from the policy engine 812 indicating which messages to send and may indicate the responses back to the policy engine 812. The PHY layer 816 is generally responsible for sending and receiving messages across the USB Type-C CC wire and for managing data. In some aspects, the PHY layer 816 may include the authentication component 220, which is configured to implement the techniques presented herein. For example, the authentication component 220 may include a PMIC block that performs encryption/decryption for the PD messages prior to sending them through the protocol layer 814.

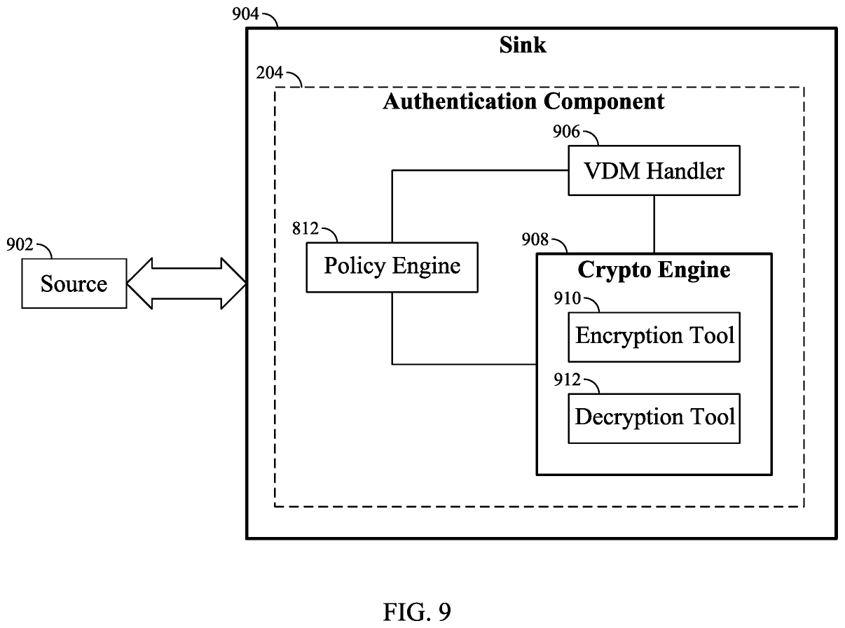

In some aspects, the authentication procedure (at block 304) may be a software-based authentication procedure. For example, in one particular aspect, the software-based authentication procedure may be based on an exchange of one or more vendor defined messages (VDMs) with the second device. FIG. 9 depicts an example of a sink device 904 configured to perform authentication of a source device 902 via VDM messages, according to certain aspects of the present disclosure.

As shown, the authentication component 204 of the sink device 904 includes a policy engine 812, a VDM handler 906, and a crypto engine 908. In this example, the authentication of VDM specific messages may be passed through the policy engine 812 and sent to the VDM handler 906, which performs authentication of the VDM specific messages via the crypto engine 908. For example, the VDM handler 906 can control encryption operations (e.g., via encryption tool 910) and/or decryption operations (e.g., via decryption tool 912) of VDM specific messages.

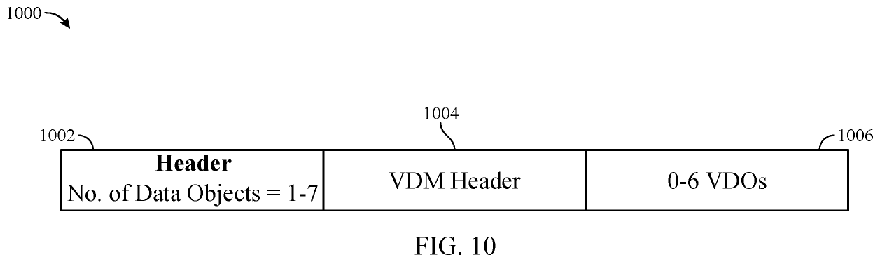

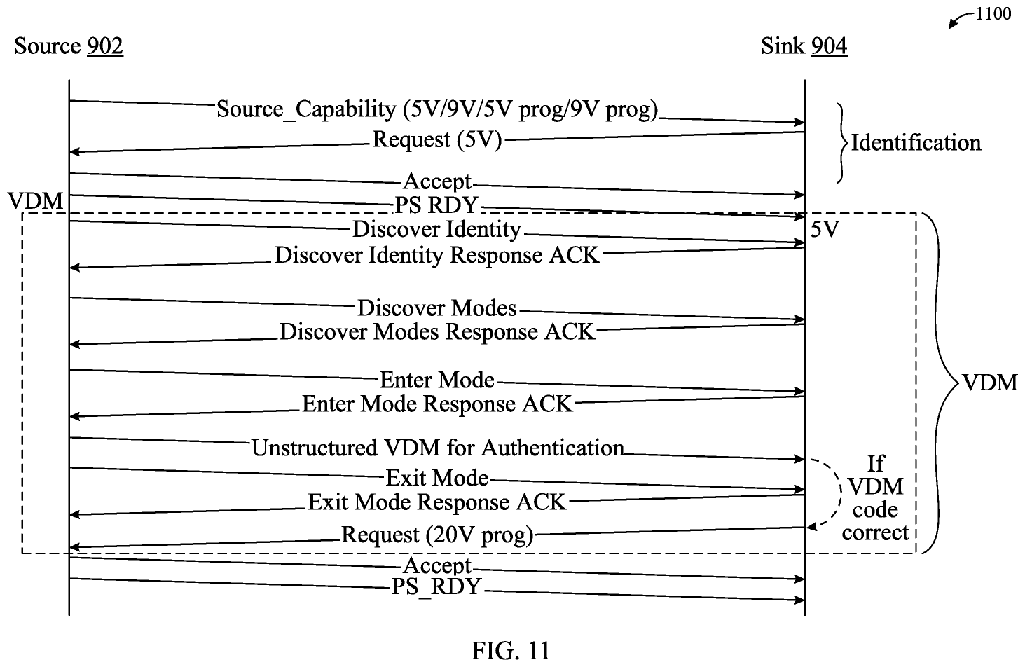

FIG. 10 illustrates an example VDM message format 1000, according to certain aspects of the present disclosure. The VDM may enable vendors to exchange information outside of that defined by a specification. That is, the VDM may allow for customized messages. As shown, the VDM message format 1000 includes a header field 1002, a VDM header field 1004, and an (encrypted) data field 1006. The data field 1006 may include one or more VDM objects (VDOs). Aspects presented herein allow devices to perform authentication based on exchange of VDM messages. FIG. 11, for example, illustrates an authentication protocol 1100 that may be implemented (e.g., by the VDM handler 906) based on VDM messages, according to certain aspects of the present disclosure.

As shown in FIG. 11, in an identification phase, the sink 904 may receive an indication of one or more capabilities of the source 902. In some aspects, the capabilities may indicate whether the source 902 is a legacy device, a non-compliant device, or is a compliant device (e.g., compliant with a standard). Subsequently, in a VDM phase, the source and sink may exchange one or more “Discover Identity” messages, “Discover Modes” messages, “Enter Mode” messages, “Authentication” messages, and “Exit Mode” messages as part of an authentication procedure.

For example, once the sink 904 detects the charging device (e.g., charging device 204) as the source 902, the sink 904 can determine, based on the “Source Capability” message, whether the source 902 is Type-C PD capable. If the source 902 is a legacy charging device, then the sink 904 may restrict the charging current of the source 902 to a default charging current (e.g., 5V/500 mA). If the source 902 is a non-compliant charging device that is able to support fast charging, then the sink 904 may authenticate the attached source 902 via one or more VDM messages (e.g., using the authentication protocol 1100). If the authentication fails (e.g., the source 902 may not support the authentication protocol, the source 902 is a counterfeit device, etc.), then the sink 904 may limit the charging current of the source 902 to a default charging current or prompt the user for a device charging control option.

In some aspects, if the source 902 is a compliant charging device and supports the authentication, the sink 904 may allow charging to continue with a max current charging level supported by the source 902. Additionally, the sink 904 may prompt the user to allow for a file transfer, e.g., assuming the source 902 has a file exchange capability.

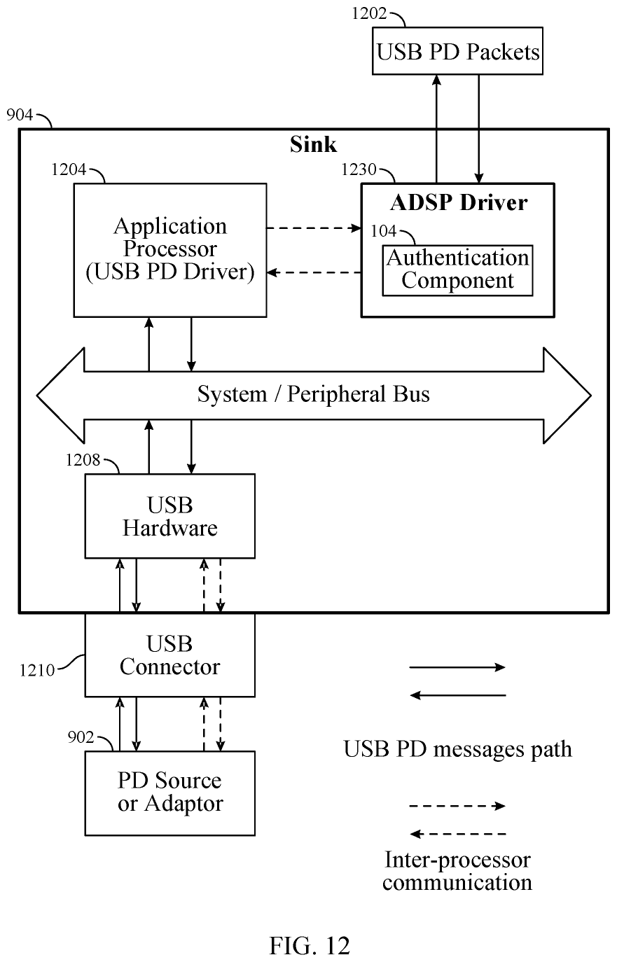

In some aspects, the software-based authentication procedure may be performed by a new (dedicated) subsystem at the software layer. FIG. 12, for example, illustrates a sink 904 with a dedicated audio digital signal processor (ADSP) 1230 that is configured to perform authentication using the authentication component 220. In particular, the ADSP 1230 can process PD packets 1202 via the authentication component 220 and send a message to the application processor 1204 to indicate whether the authentication succeeded or failed. In some cases, the ADSP 1230 can control, via USB hardware 1208, whether USB data signals are sent to the USB connector 1210, based on a result of the authentication procedure. Disabling the USB data path in this manner can protect the sink device port.

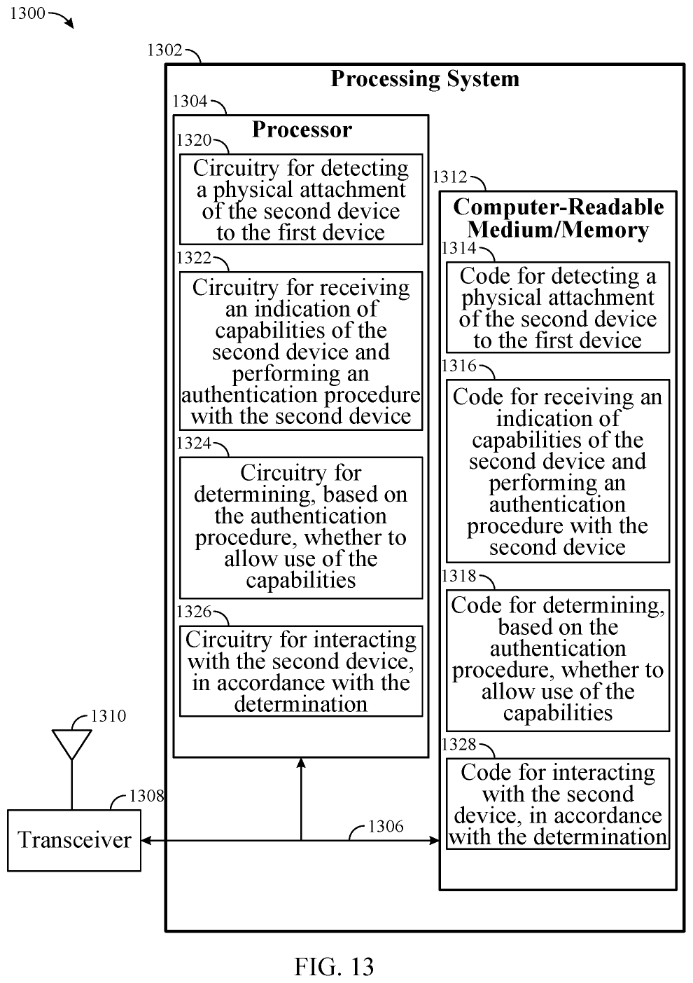

FIG. 13 illustrates a communications device 1300 that may include various components (e.g., corresponding to means-plus-function components) configured to perform operations for the techniques disclosed herein, such as the operations illustrated in FIG. 3. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 3, or other operations for performing the various techniques discussed herein. In certain aspects, computer-readable medium/memory 1312 stores code 1314 for detecting a physical attachment of the second device to the first device; code 1316 for receiving, in response to the detection, an indication of one or more capabilities of the second device and performing an authentication procedure with the second device; code 1318 for determining, based on the authentication procedure, whether to allow use of the one or more capabilities of the second device; and code 1328 for interacting with the second device, in accordance with the determination. In certain aspects, the processor 1304 has circuitry configured to implement the code stored in the computer-readable medium/memory 1312. The processor 1304 includes circuitry 1320 for detecting a physical attachment of the second device to the first device; circuitry 1322 for receiving, in response to the detection, an indication of one or more capabilities of the second device and performing an authentication procedure with the second device; circuitry 1324 for determining, based on the authentication procedure, whether to allow use of the one or more capabilities of the second device; and circuitry 1326 for interacting with the second device, in accordance with the determination.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules, and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a charging device or a device to be charged. The processing system may be implemented with bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through external bus architecture. Alternatively, the processing system may be implemented with an ASIC with the processor, the bus interface, the user interface in the case of an access terminal), supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A computer-implemented method performed by a first device for authenticating a second device physically attached to the first device, the computer-implemented method comprising:
detecting a physical attachment of the second device to the first device;
in response to the detection, receiving an indication of one or more capabilities of the second device and performing an authentication procedure with the second device;
determining, based on the authentication procedure, whether to allow use of the one or more capabilities of the second device; and
interacting with the second device, in accordance with the determination.

2. The computer-implemented method of claim 1, wherein the authentication procedure is a hardware-based authentication procedure.

3. The computer-implemented method of claim 2, wherein the hardware-based authentication procedure is performed at a physical layer of the first device.

4. The computer-implemented method of claim 1, wherein the authentication procedure is a software-based authentication procedure.

5. The computer-implemented method of claim 4, wherein the software-based authentication procedure is based on an exchange of one or more vendor defined messages with the second device.

6. The computer-implemented method of claim 4, wherein the software-based authentication procedure is performed by an audio digital signal processor (ADSP) of the first device.

7. The computer-implemented method of claim 1, wherein the one or more capabilities comprises at least one of: (i) support for charging at one or more supported charge currents or (ii) support for data exchange.

8. The computer-implemented method of claim 1, wherein performing the authentication procedure comprises determining whether the second device supports a same maximum charging current supported by the first device.

9. The computer-implemented method of claim 1, wherein performing the authentication procedure comprises determining whether the second device is in compliance with a standard.

10. The computer-implemented method of claim 9, wherein the standard is based on a Universal Serial Bus (USB) Type-C Power Delivery (PD) specification.

11. The computer-implemented method of claim 1, wherein determining whether to allow use of the one or more capabilities of the second device comprises determining to allow use of a subset of the one or more capabilities of the second device if the second device is not successfully authenticated.

12. The computer-implemented method of claim 11, wherein the subset of the one or more capabilities comprises a charge current below a predefined threshold charge current.

13. The computer-implemented method of claim 1, further comprising prompting a user to approve use of the one or more capabilities of the second device, based on the authentication procedure, prior to interacting with the second device.

14. The computer-implemented method of claim 13, wherein determining whether to allow use of the one or more capabilities of the second device is further based on whether the user has approved use of the one or more capabilities of the second device.

15. The computer-implemented method of claim 1, wherein determining whether to allow use of the one or more capabilities of the second device comprises determining to allow use of the one or more capabilities of the second device if the second device is successfully authenticated.

16. An apparatus comprising:
at least one processor configured to perform an operation for authenticating a device physically attached to the apparatus, the operation comprising:
detecting a physical attachment of the device to the apparatus;
in response to the detection, receiving an indication of one or more capabilities of the device and performing an authentication procedure with the device;
determining, based on the authentication procedure, whether to allow use of the one or more capabilities of the device; and
interacting with the device, in accordance with the determination; and
a memory coupled to the at least one processor.

17. The apparatus of claim 16, wherein the authentication procedure is a hardware-based authentication procedure performed at a physical layer of the apparatus.

18. The apparatus of claim 16, wherein the authentication procedure is a software-based authentication procedure that comprises an exchange of one or more vendor defined messages with the device.

19. A non-transitory computer readable medium having computer-executable code stored thereon, which when executed by one or more computer processors of a first device, performs an operation for authenticating a second device physically attached to the first device, the operation comprising:
detecting a physical attachment of the second device to the first device;
in response to the detection, receiving an indication of one or more capabilities of the second device and performing an authentication procedure with the second device;
determining, based on the authentication procedure, whether to allow use of the one or more capabilities of the second device; and
interacting with the second device, in accordance with the determination.

20. The non-transitory computer-readable medium of claim 19, wherein the authentication procedure is a hardware-based authentication procedure or a software-based authentication procedure.
